(19) United States
(12) Patent Application Publication
(10) Pub. No.: US 2022/0149357 A1
(43) Pub. Date: May 12, 2022

(54) BATTERY AND METHOD OF MANUFACTURING SAME

(71) Applicant: Prime Planet Energy & Solutions, Inc., Tokyo (JP)

(72) Inventors: Toshiki IMABORI, Kasai-shi (JP); Kohji UMEMURA, Ono-shi (JP); Koichi TANIMOTO, Takarazuka-shi (JP)

(21) Appl. No.: 17/519,521

(22) Filed: Nov. 4, 2021

(30) Foreign Application Priority Data
Nov. 6, 2020 (JP) 2020-185730

(51) Int. Cl. H01M 4/36; H01M 4/66; H01M 4/04

(52) U.S. Cl. CPC H01M 4/366; H01M 4/0404; H01M 4/667

(57) ABSTRACT

A layered portion is formed by layering an electrode core body. The layered portion has a first outer surface and a second outer surface opposite to each other. The first outer surface of the layered portion is connected to a current collector that is in a form of a plate. A first protrusion/recess region is formed in the second outer surface of the layered portion. A second protrusion/recess region is formed in an outer surface of the current collector located opposite to the layered portion. A width of the second protrusion/recess region is 1.3 times or more and 2.0 times or less as large as a width of the first protrusion/recess region. A curved portion is formed at a portion at which the layered portion and the current collector are connected to each other.

This nonprovisional application is based on Japanese Patent Application No. 2020-185730 filed on Nov. 6, 2020, with the Japan Patent Office, the entire contents of which are hereby incorporated by reference.

### BACKGROUND OF THE INVENTION

### Field of the Invention

The present technology relates to a battery and a method of manufacturing the battery.

### Description of the Background Art

Conventionally, in a prismatic secondary battery, an uncovered portion, which is constituted of a layered portion of a metal foil, of an electrode assembly has been joined to a current collector by welding. Such a configuration is described, for example, in Japanese Patent Laying-Open No. 2016-143618 (PTL 1).

When the current collector undergoes bending deformation, detachment may occur at a joining portion between an electrode assembly and a current collector. In order to suppress such detachment, there is required a simple structure by which bending deformation of the layered portion and the current collector is less likely to occur. In view of this, the conventional structure is not necessarily sufficient.

### SUMMARY OF THE INVENTION

An object of the present technology is to provide: a battery in which detachment can be suppressed at a joining portion between an electrode assembly and a current collector; and a method of manufacturing the battery.

A battery according to the present technology includes an electrode assembly including an electrode plate having an electrode core body and an electrode active material layer formed on the electrode core body. A layered portion is formed by layering the electrode core body. The layered portion has a first outer surface and a second outer surface opposite to each other. The first outer surface of the layered portion is connected to a current collector that is in a form of a plate. A first protrusion/recess region is formed in the second outer surface of the layered portion. A second protrusion/recess region is formed in an outer surface of the current collector located opposite to the layered portion. A width of the second protrusion/recess region is 1.3 times or more and 2.0 times or less as large as a width of the first protrusion/recess region. A curved portion is formed at a portion at which the layered portion and the current collector are connected to each other.

A method of manufacturing a battery according to the present technology includes: preparing an electrode assembly including an electrode plate having an electrode core body and an electrode active material layer formed on the electrode core body; forming a layered portion by layering the electrode core body, the layered portion having a first outer surface and a second outer surface opposite to each other; and ultrasonically joining the first outer surface of the layered portion and a current collector to each other. The ultrasonically joining includes: placing a horn on the layered portion side and placing an anvil on the current collector side, the horn having a first width, the anvil having a second width that is 1.3 times or more and 2.0 times or less as large as the first width; and curving the layered portion and the current collector by pressing the horn toward the anvil.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a battery.

FIG. 2 is a diagram showing a configuration of an electrode assembly.

FIG. 3 is a diagram showing a connection portion between a current collector and the electrode assembly.

FIG. 4 is a diagram showing the connection portion shown in FIG. 3 when viewed in a Y axis direction.

FIG. 5 is a diagram showing a step of ultrasonically joining the current collector and the electrode assembly to each other.

FIG. 6 is a diagram for illustrating a method of measuring bending strength of the current collector.

FIG. 7 is a diagram showing a relation between the bending strength of the current collector and an anvil width/horn width.

FIG. 8 is a diagram showing a relation between the anvil width/horn width and an amount of curve of the layered portion and the current collector.

### DESCRIPTION OF THE PREFERRED EMBODIMENTS

Hereinafter, embodiments of the present technology will be described. It should be noted that the same or corresponding portions are denoted by the same reference characters and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly.

It should be noted that in the present specification, the terms “comprise”, “include”, and “have” are open-end terms. That is, a certain configuration is included but inclusion of a configuration other than the foregoing configuration is not excluded.

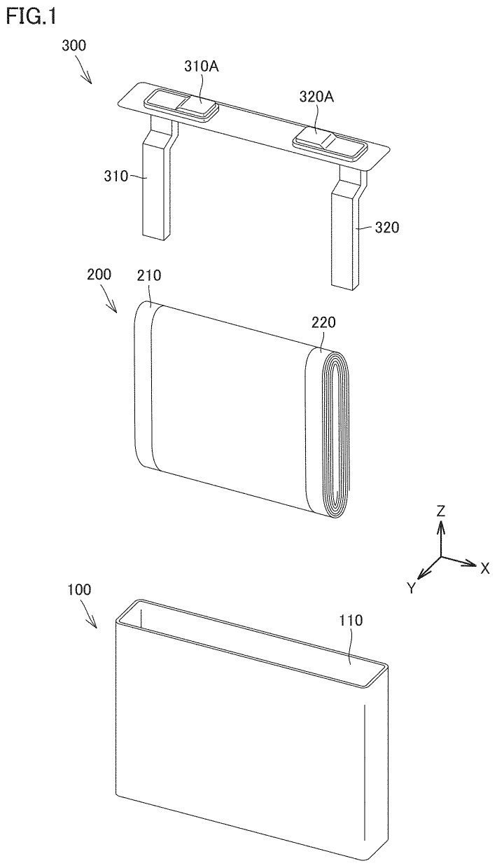

FIG. 1 is an exploded perspective view of a battery. As shown in FIG. 1, the battery according to the present embodiment includes a prismatic exterior body 100, an electrode assembly 200, and a cover member 300.

Prismatic exterior body 100 is provided with an opening 110 that opens upward. An electrolyte solution (not shown) is accommodated in prismatic exterior body 100 together with electrode assembly 200. Electrode assembly 200 has a positive electrode 210 and a negative electrode 220 that are arranged side by side in an X axis direction.

Cover member 300 closes opening 110 of prismatic exterior body 100. Cover member 300 has an upper surface on which a positive electrode external terminal 310A and a negative electrode external terminal 320A are provided with a space being interposed therebetween in the X axis direction. A positive electrode side current collector 310 and a negative electrode side current collector 320 are provided on a lower surface of cover member 300. Positive electrode side current collector 310 is electrically connected to positive electrode external terminal 310A. Negative electrode side current collector 320 is electrically connected to negative electrode external terminal 320A.

Further, current collector 310 is connected to positive electrode 210 of electrode assembly 200, and current collector 320 is connected to negative electrode 220 of electrode assembly 200. Thus, positive electrode 210 and negative electrode 220 of electrode assembly 200 are electrically connected to positive electrode external terminal 310A and negative electrode external terminal 320A of cover member 300.

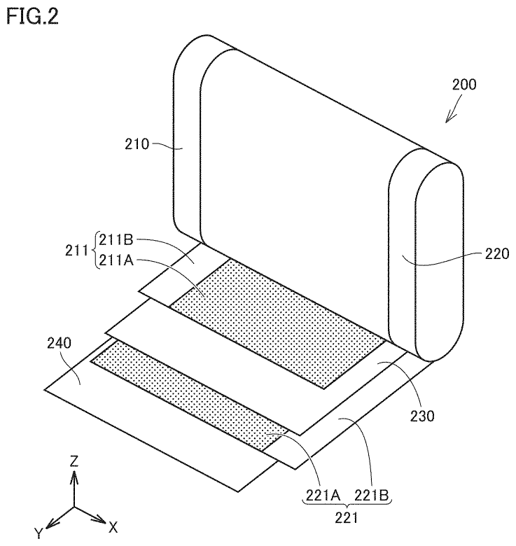

FIG. 2 is a diagram showing a configuration of electrode assembly 200. As shown in FIG. 2, electrode assembly 200 includes: a positive electrode plate 211 that forms positive electrode 210; a negative electrode plate 221 that forms negative electrode 220; and separators 230, 240.

Positive electrode plate 211 has: a first region 211A in which positive electrode active material composite layers (first active material layers) are formed on both surfaces of a positive electrode core body (first electrode core body) composed of an aluminum foil, each of the positive electrode active material composite layers including a positive electrode active material (for example, lithium nickel cobalt manganese composite oxide), a binder (for example, polyvinylidene difluoride (PVdF)), and a conductive material (for example, carbon material); and a second region 211B in which the active material layers are not formed and the positive electrode core body is exposed.

It should be noted that a protective layer (not shown) including alumina particles, a binder, and a conductive material may be provided on a portion of second region 211B (portion adjacent to first region 211A).

Negative electrode plate 221 has: a first region 221A in which negative electrode active material layers (second active material layers) are formed on both surfaces of a negative electrode core body (second electrode core body) composed of a copper foil; and a second region 221B in which the active material layers are not formed and the negative electrode core body is exposed.

Positive electrode plate 211 and negative electrode plate 221 are wound around the X axis (winding axis) to form a flat shape with separators 230, 240 being interposed therebetween. In this way, electrode assembly 200 is formed to have: positive electrode 210 located on the one end portion (first end portion) side along the X axis direction (first direction); and negative electrode 220 located on the other end portion (second end portion) side.

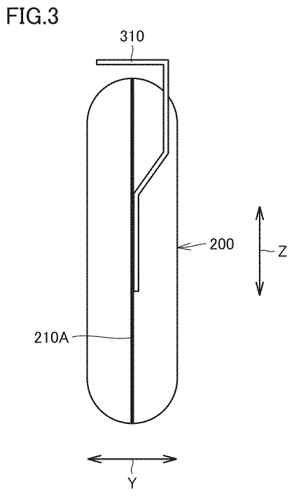

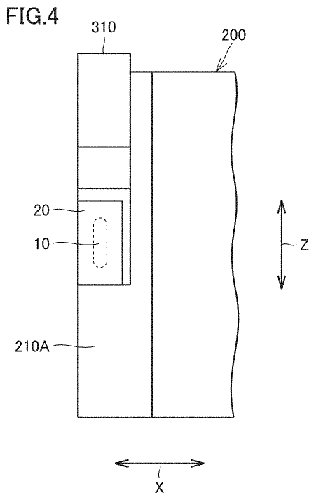

FIG. 3 is a diagram showing a connection portion between current collector 310 and electrode assembly 200. FIG. 4 is a diagram showing the connection portion shown in FIG. 3 when viewed in the Y axis direction. It should be noted that in the following example, a structure on the positive electrode 210 side will be described, but the same structure can be applied to the negative electrode 220 side.

As shown in FIGS. 3 and 4, second region 211B of positive electrode plate 211 located at an end portion of electrode assembly 200 on the positive electrode 210 side is concentrated to form a layered portion 210A. Current collector 310 is ultrasonically joined to layered portion 210A. Thus, positive electrode 210 of electrode assembly 200 and positive electrode external terminal 310A of cover member 300 are electrically connected to each other.

In the event of the ultrasonic joining, as shown in FIG. 4, a first protrusion/recess region 10 is formed in layered portion 210A of electrode assembly 200, and a second protrusion/recess region 20 is formed in current collector 310. The shapes and the like of first protrusion/recess region 10 and second protrusion/recess region 20 will be described later.

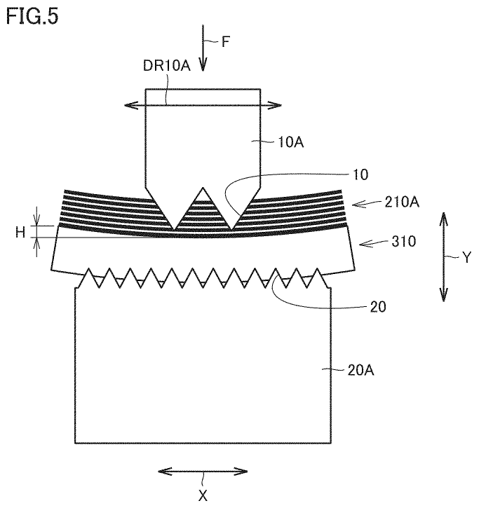

FIG. 5 is a diagram showing a step of ultrasonically joining current collector 310 and electrode assembly 200 to each other. As shown in FIG. 5, layered portion 210A and current collector 310 are ultrasonically joined to each other using a horn 10A and an anvil 20A.

On this occasion, horn 10A is placed on the layered portion 210A side, and anvil 20A is placed on the current collector 310 side. The width (second width) of anvil 20A in the X axis direction is larger than the width (first width) of horn 10A in the X axis direction. More specifically, the width of anvil 20A in the X axis direction is about 1.3 times or more and 2.0 times or less as large as the width of horn 10A in the X axis direction.

Layered portion 210A and current collector 310 are ultrasonically joined to each other by vibrating horn 10A in a direction of arrow DR10A with horn 10A being pressed toward anvil 20A (as an example, pressing force is about 800 N). On this occasion, the amplitude of the vibration of horn 10A is about more than or equal to 10 μm and less than or equal to 50 μm.

Here, since the width of anvil 20A is larger than (about 1.3 times or more as large as) the width of horn 10A, layered portion 210A and current collector 310 are curved as shown in FIG. 5 when performing the ultrasonic joining with horn 10A being pressed toward anvil 20A. More specifically, layered portion 210A and current collector 310 are curved in a direction in which both ends of current collector 310 in the width direction of current collector 310 come closer to layered portion 210A.

Since layered portion 210A and current collector 310 are curved as described above, an arch structure is formed at the curved portion, thereby improving bending strength (resistance against deformation of current collector 310) when force in the Y axis direction acts on current collector 310. As a result, joining strength between layered portion 210A and current collector 310 can be improved to suppress detachment of layered portion 210A from current collector 310 even when force in the Y axis direction acts on current collector 310.

The force in the Y axis direction may act on current collector 310 in a tensile inspection step, a step of insertion into prismatic exterior body 100, a step of activation of the battery, and the like in the manufacturing steps of the battery. On these occasions, it is required to suppress detachment of layered portion 210A from current collector 310.

The lower surface (first outer surface) of layered portion 210A shown in FIG. 5 is connected to current collector 310 that is in the form of a plate. First protrusion/recess region 10 corresponding to protrusion/recess of horn 10A is formed in the upper surface (second outer surface) of layered portion 210A. Second protrusion/recess region 20 corresponding to protrusion/recess of anvil 20A is formed in an outer surface of current collector 310 located opposite to layered portion 210A. Since the width of anvil 20A is about 1.3 times or more and 2.0 times or less as large as the width of horn 10A, the width of second protrusion/recess region 20 is about 1.3 times or more and 2.0 times or less as large as the width of first protrusion/recess region 10.

In second protrusion/recess region 20, a region (first region) overlapping with first protrusion/recess region 10 and regions (second regions) other than first protrusion/recess region 10 have shapes different in terms of the protrusion/recess pattern.

More specifically, the central portion (first region) of second protrusion/recess region 20 overlaps with first protrusion/recess region 10 in the width direction (X axis direction) of current collector 310, and is stuck deeper with the protrusion/recess of the surface of anvil 20A than each of the end portions (second regions) of current collector 310 in the width direction (X axis direction) of current collector 310. As a result, the depth of each recess portion of second protrusion/recess region 20 is relatively deep at the central portion of current collector 310 in the width direction of current collector 310.

It should be noted that the curve of layered portion 210A and current collector 310 is preferably formed only in a region in which horn 10A is located, i.e., in a region in which first protrusion/recess region 10 is formed in the height direction (Z axis direction) of current collector 310. Alternatively, current collector 310 may be curved in the direction shown in FIG. 5 in advance before performing the ultrasonic joining.

Referring to FIG. 4 again, the center of second protrusion/recess region 20 is formed at a position displaced from the center of current collector 310 in the width direction (X axis direction) of current collector 310. However, the center of second protrusion/recess region 20 may coincide with the center of current collector 310.

Similarly, in the example of FIG. 4, second protrusion/recess region 20 is formed to reach the end portion of current collector 310 in the width direction (X axis direction) of current collector 310. However, second protrusion/recess region 20 does not necessarily need to reach the end portion of current collector 310 in the width direction of current collector 310.

For example, when the width of current collector 310 is about 6.8 mm and the thickness thereof is about 0.8 mm, each of the amount of curve (H) of layered portion 210A and current collector 310 and the maximum depth of the recess portion of second protrusion/recess region 20 is preferably about more than or equal to 0.2 mm. That is, each of the amount of curve (H) of layered portion 210A and current collector 310 and the maximum depth of the recess portion of second protrusion/recess region 20 is preferably more than or equal to about 3% (0.2/6.8≈0.0294) of the width of current collector 310. Further, each of the amount of curve (H) of layered portion 210A and current collector 310 and the maximum depth of the recess portion of second protrusion/recess region 20 is more than or equal to about 25% (0.2/0.8=0.25) of the thickness of current collector 310.

By securing such an amount of curve, the bending strength of current collector 310 joined to layered portion 210A can be made high, thereby improving the effect of suppressing detachment of layered portion 210A from current collector 310.

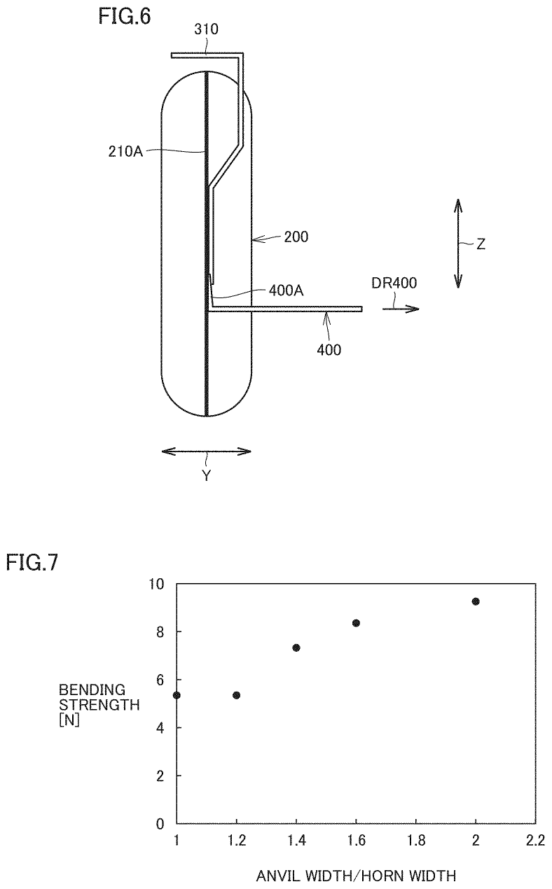

FIG. 6 is a diagram for illustrating a method of measuring the bending strength of current collector 310. The “bending strength [N]” is measured in the following manner: as shown in FIG. 6, a claw 400A provided at the tip of a jig 400 is inserted between layered portion 210A and current collector 310 and is pulled in a direction of arrow DR400 to increase a tensile load, and a load with which current collector 310 is deformed to be detached from layered portion 210A is measured.

FIG. 7 is a diagram showing a relation between the bending strength of the current collector and a ratio (anvil width/horn width) of the width of anvil 20A and the width of horn 10A. The vertical axis in FIG. 7 represents the “bending strength [N]” measured by the method using jig 400 shown in FIG. 6, and the horizontal axis in FIG. 7 represents the value of the “anvil width/horn width” determined in accordance with the widths of horn 10A and anvil 20A. Here, a horn having a width of less than or equal to 4.8 mm is used as horn 10A, whereas an anvil having a width of less than or equal to 6 mm is used as anvil 20A. The width of current collector 310 is 6.8 mm.

As shown in FIG. 7, it was indicated that the bending strength [N] is relatively high when the anvil width/horn width is more than 1.3 (anvil width/horn width=1.4, 1.6, or 2).

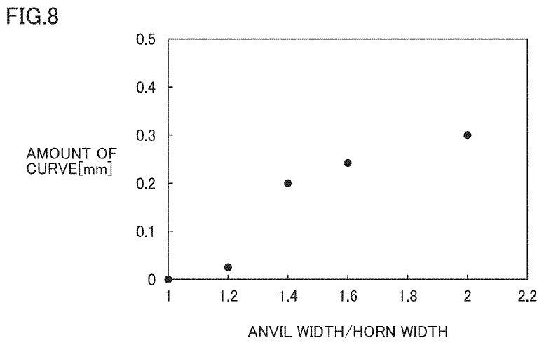

FIG. 8 is a diagram showing a relation between the anvil width/horn width and the amount of curve of the layered portion and the current collector. The vertical axis in FIG. 8 represents the amount of curve of layered portion 210A and current collector 310, and the horizontal axis in FIG. 8 represents the value of the “anvil width/horn width” determined in accordance with the widths of horn 10A and anvil 20A as with FIG. 7.

As shown in FIG. 8, it was indicated that the amount of curve [mm] is relatively large (H≥0.2 mm) when the anvil width/horn width is larger than 1.3 (anvil width/horn width=1.4, 1.6, or 2).

In view of the results shown in FIGS. 7 and 8, it is indicated that by setting the widths of horn 10A and anvil 20A to attain an anvil width/horn width of about more than or equal to 1.3, the bending strength of current collector 310 joined to layered portion 210A can be made high to suppress detachment of layered portion 210A from current collector 310.

Although the embodiments of the present invention have been described and illustrated in detail, it is clearly understood that the same is by way of illustration and example only and is not to be taken by way of limitation, the scope of the present invention being interpreted by the terms of the appended claims.

What is claimed is:

1. A battery comprising an electrode assembly including an electrode plate having an electrode core body and an electrode active material layer formed on the electrode core body, wherein
a layered portion is formed by layering the electrode core body,
the layered portion has a first outer surface and a second outer surface opposite to each other,
the first outer surface of the layered portion is connected to a current collector that is in a form of a plate,
a first protrusion/recess region is formed in the second outer surface of the layered portion,
a second protrusion/recess region is formed in an outer surface of the current collector located opposite to the layered portion, and a width of the second protrusion/recess region is 1.3 times or more and 2.0 times or less as large as a width of the first protrusion/recess region, and
a curved portion is formed at a portion at which the layered portion and the current collector are connected to each other.

2. The battery according to claim 1, wherein the layered portion and the current collector are curved in a direction in which both ends of the current collector in a width direction of the current collector come closer to the layered portion.

3. The battery according to claim 1, wherein an amount of curve of the layered portion and the current collector is more than or equal to 0.2 mm.

4. The battery according to claim 1, wherein
the second protrusion/recess region of the current collector includes a first region and a second region different from the first region, and
a protrusion/recess pattern of the second protrusion/recess region has shapes different between the first region and the second region.

5. The battery according to claim 4, wherein
the first region is located at a central portion of the second protrusion/recess region in a width direction of the current collector, and the second region is located beside each of both sides of the first region, and
a depth of a recess portion of the second protrusion/recess region in the first region is deeper than a depth of a recess portion of the second protrusion/recess region in the second region.

6. The battery according to claim 1, wherein a center of the second protrusion/recess region is formed at a position displaced from a center of the current collector in a width direction of the current collector.

7. The battery according to claim 1, wherein the second protrusion/recess region is formed to reach an end portion of the current collector in a width direction of the current collector.

8. The battery according to claim 1, wherein a maximum depth of a recess portion of the second protrusion/recess region is more than or equal to 0.2 mm.

9. The battery according to claim 1, wherein an amount of curve of the layered portion and the current collector is more than or equal to 3% of a width of the current collector.

10. A method of manufacturing a battery, the method comprising:
preparing an electrode assembly including an electrode plate having an electrode core body and an electrode active material layer formed on the electrode core body;
forming a layered portion by layering the electrode core body, the layered portion having a first outer surface and a second outer surface opposite to each other; and
ultrasonically joining the first outer surface of the layered portion and a current collector to each other, wherein
the ultrasonically joining includes
placing a horn on the layered portion side and placing an anvil on the current collector side, the horn having a first width, the anvil having a second width that is 1.3 times or more and 2.0 times or less as large as the first width, and
curving the layered portion and the current collector by pressing the horn toward the anvil.

11. The method of manufacturing the battery according to claim 10, wherein the layered portion and the current collector are curved in a direction in which both ends of the current collector in a width direction of the current collector come closer to the layered portion.

12. The method of manufacturing the battery according to claim 10, wherein an amount of curve of the layered portion and the current collector is more than or equal to 0.2 mm.

13. The method of manufacturing the battery according to claim 10, wherein
the current collector includes a first region and a second region different from the first region, and
an amount of being stuck with protrusion/recess of a surface of the anvil in the ultrasonically joining is different between the first region and the second region.

14. The method of manufacturing the battery according to claim 13, wherein in the ultrasonically joining, a central portion of the current collector in a width direction of the current collector is stuck deeper with the protrusion/recess of the surface of the anvil than an end portion of the current collector in the width direction of the current collector.

15. The method of manufacturing the battery according to claim 10, wherein in the ultrasonically joining, the anvil is provided at a position displaced from a center of the current collector in a width direction of the current collector.

16. The method of manufacturing the battery according to claim 10, wherein in the ultrasonically joining, the anvil is provided to reach an end portion of the current collector in a width direction of the current collector.

17. The method of manufacturing the battery according to claim 10, wherein a depth of a recess portion of the anvil is more than or equal to 0.2 mm.

18. The method of manufacturing the battery according to claim 10, wherein a depth of a recess portion of the anvil is more than or equal to 3% of a width of the current collector.
